(19) United States
(12) Patent Application Publication
(10) Pub. No.: US 2014/0122238 A1
(43) Pub. Date: May 1, 2014

(54) COUPON OFFER PERSONALIZATION

(71) Applicant: HEWLETT-PACKARD DEVELOPMENT COMPAN, Houston, TX (US)

(72) Inventors: Jon K. Lewis, Vancouver, WA (US); Dave Bettineski, Camas, WA (US); Jonathan Newman, Portland, OR (US)

(73) Assignee: HEWLETT-PACKARD DEVELOPMENT COMPANY, L.P., Houston, TX (US)

(21) Appl. No.: 13/664,103

(22) Filed: Oct. 30, 2012

(51) Int. Cl. G06Q 30/02

(52) U.S. Cl. 705/14.58

(57) ABSTRACT

A method for coupon offer personalization includes receiving information related to a location and a search criterion for coupon offers, and outputting coupon offers for selection based on the location and the search criterion. The method includes evaluating a selection history of coupon offers selected by a user from the output coupon offers. The method further includes determining if the selected coupon offers are a predetermined distance apart, and determining if a number of the selected coupon offers exceeds a predetermined threshold. If the selected coupon offers are the predetermined distance apart and if the number of the selected coupon offers exceeds the predetermined threshold, the method includes designating a location of the selected coupon offers as a location of interest to the user. The method further includes determining additional coupon offers in proximity to the location of interest to the user.

### BACKGROUND

Typical digital coupon offer websites may use a user's zip code or geolocate the user's internet protocol (IP) address to determine location to improve the viewing experience of local coupon offers. For example, a digital coupon offer website may use the user's zip code to locate coupon offers within a search area including the user's zip code, with the search area being defined by a predetermined radius. The predetermined radius may be configured by the user to expand or reduce the coupon offer search area. A digital coupon offer website may also allow a user to enter multiple locations, such as the user's home or work locations.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a coupon offer personalization apparatus, according to an example of the present disclosure;

FIG. 2 illustrates a map showing a coupon offer search area including several zip codes, according to an example of the present disclosure;

FIG. 3 illustrates another map showing a coupon offer search area including zip codes adjacent boundaries of the coupon offer search area, according to an example of the present disclosure;

FIG. 4 illustrates an example of multiple inferred locations, according to an example of the present disclosure;

FIG. 5 illustrates a method for coupon offer personalization, according to an example of the present disclosure; and

FIG. 6 illustrates a computer system, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

A coupon offer personalization apparatus and a method for coupon offer personalization are described, and generally provide personalization of local coupon offers that may be determined based, for example, on a search of available coupon offers in a search area defined by a user's zip code. The search area may be based on a fixed or configurable radius (e.g., 10 miles, 20 miles, etc.) and include the user's zip code. For example, based on a user's zip code, a center point of the zip code may be determined. The latitude and longitudinal coordinates of the zip code center point may be used to determine the search area, and calculate a distance of coupon offers within the search area defined by the user's zip code from the user's zip code center point. The coordinates of the coupon offers may also be based on latitude and longitude coordinates. Coupon offers that are closer to the zip code center point may be ranked higher than coupon offers that are further away. For example, coupon offers may be assigned weights based on distance from the zip code center point, and ranked according to the assigned weights.

The coupon offer personalization apparatus and the method for coupon offer personalization may further utilize print history to define clusters of printing that provide multiple center points to rank coupon offers appropriately. For example, clusters of three or more printed coupon offers may be used to triangulate new center point locations. The newly discovered center point locations may be used to further discover possible home, work and other locations relevant to a user. For multiple locations discovered based on clustering, such locations may be weighted based, for example, on print history, offer categories, frequency of coupon offer selection, etc. Further, user actions, such as print, like, dislike, hide, etc., may be incorporated into the weighting for each location. For example, disliking a set of categories for a specific location may be used to eliminate or lower the ranking of possible coupon offers for a newly discovered center point location.

According to an example, a method for coupon offer personalization includes receiving information (e.g., a zip code, or a specific address) related to a location, receiving information related to a search criterion for coupon offers relative to the location, and outputting coupon offers for selection based on the location and the search criterion within a predetermined range of the location. The method includes evaluating a selection history of coupon offers selected by a user from the output coupon offers, with the coupon offers selected by the user being designated selected coupon offers. The method further includes determining if the selected coupon offers are a predetermined distance apart, and determining if a number of the selected coupon offers exceeds a predetermined threshold. If the selected coupon offers are the predetermined distance apart and if the number of the selected coupon offers exceeds the predetermined threshold, the method includes designating a location of the selected coupon offers as a location of interest to the user. The method further includes determining additional coupon offers in proximity to the location of interest to the user.

For the example of the method described herein, evaluating a selection history of a plurality of coupon offers selected by a user from the output coupon offers may further include determining distances between a center point of the location and the selected coupon offers. The method may further include determining the distances based on latitude and longitude coordinates of the center point of the location and the selected coupon offers.

For the example of the method described herein, determining if a number of the selected coupon offers exceeds a predetermined threshold may further include determining if the selected coupon offers are related to a category, and determining if the number of the selected coupon offers related to the category exceeds a predetermined threshold related to the category. The category may be modifiable by the user. Alternatively, determining if a number of the selected coupon offers exceeds a predetermined threshold may further include determining if the selected coupon offers are related to a user action (e.g., liking, disliking, or hiding a coupon offer), and determining if the number of the selected coupon offers related to the user action exceeds a predetermined threshold related to the user action.

For the example of the method described herein, the predetermined threshold may include two coupon offers, and the method may further include determining the location of interest to the user based on triangulation using locations of at least three of the selected coupon offers. Determining additional coupon offers in proximity to the location of interest to the user may further include determining the additional coupon offers within a predetermined distance to the location of interest to the user.

The method may further include assigning one or more weights to each of the selected coupon offers and the additional coupon offers based, for example, on categories of the selected coupon offers and the additional coupon offers, locations of the selected coupon offers and the additional coupon offers, frequency of selection of the selected coupon offers, and/or actions performed by the user related to the selected coupon offers. The method may also include assigning one or more weights to each of the selected coupon offers and the additional coupon offers, determining a score for each of the selected coupon offers and the additional coupon offers based on the assigned weights, and ranking the selected coupon offers and the additional coupon offers based on the score for each of the selected coupon offers and the additional coupon offers. The method may further include assigning one or more weights to each of the selected coupon offers, assigning a time stamp to each of the selected coupon offers, determining a decay rate of each of selected coupon offers from the time stamp, and modifying the one or more assigned weights based on the decay rate.

The coupon offer personalization apparatus and the method for coupon offer personalization thus use limited user input and user interactions to self-discover possible locations of interest to a user, to generate possible coupon offers in such possible locations, and to automatically rank coupon offers based on a variety of predetermined and user configurable factors.

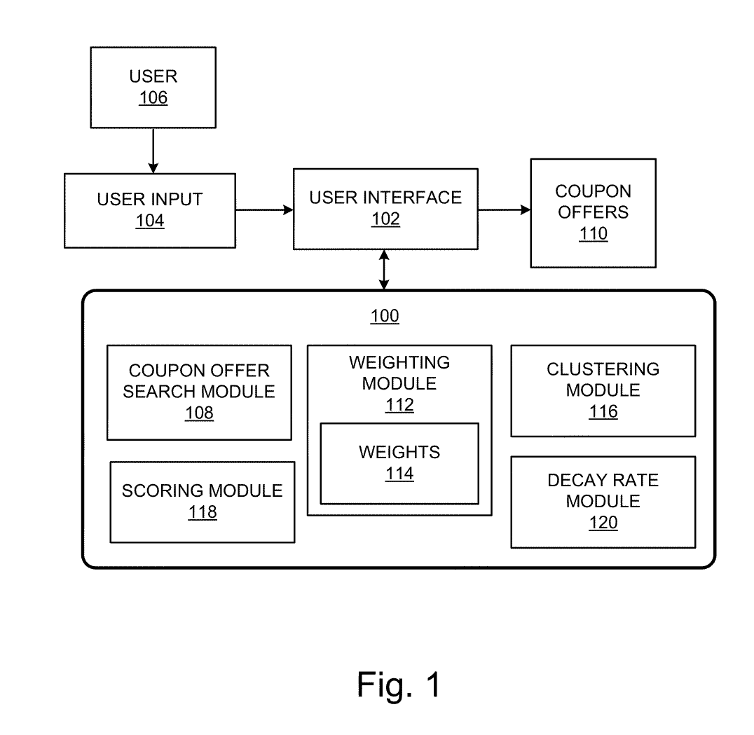

FIG. 1 illustrates an architecture of a coupon offer personalization apparatus 100, according to an example. Referring to FIG. 1, the apparatus 100 is depicted as including a user interface 102 that is to receive user input 104 from a user 106 related, for example, to a location for retrieving coupon offers, coupon offer categories of interest, etc. For coupon offers, the user interface 102 may further receive user input 104 related to user preferences, such as like, dislike, hide, etc. A coupon offer search module 108 is to search for coupon offers, for example, in a location entered by the user 106, and output coupon offers 110 that match appropriate search criteria. A weighting module 112 is to assign weights 114 to the coupon offers 110 determined by the coupon offer search module 108. The user interface 102 may be used by the user 106 to modify the weights 114. A clustering module 116 is to cluster coupon offers that may be printed by the user 106 to discover new center points for locations that may be of interest to the user 106. The discovery of new center points for locations that may be of interest to the user 106 thus provides for discovery of new locations based on user behavior. For multiple locations discovered based on clustering, such locations may be assigned the weights 114 by the weighting module 112, with the weights 114 being based, for example, on print history, offer categories (i.e., restaurant offers, grocery offers), frequency of coupon offer selection, etc. Further, user actions, such as print, like, dislike, hide, etc., may be incorporated into the weighting for each location and/or each coupon offer. A scoring module 118 is to determine scores for each coupon offer, based, for example, on the various weights assigned by the weighting module 112. The scores determined by the scoring module 118 may be used, for example, to display the coupon offers by relevancy to the user 106. A decay rate module 120 is to determine a decay rate of any actions performed by the user 106 such that more recent user actions are assigned a higher weight compared to older user actions.

The modules 108, 112, 116, 118 and 120, and other components of the apparatus 100 that perform various other functions in the apparatus 100, may comprise machine readable instructions stored on a computer readable medium. In addition, or alternatively, the modules 108, 112, 116, 118 and 120, and other components of the apparatus 100 may comprise hardware or a combination of machine readable instructions and hardware.

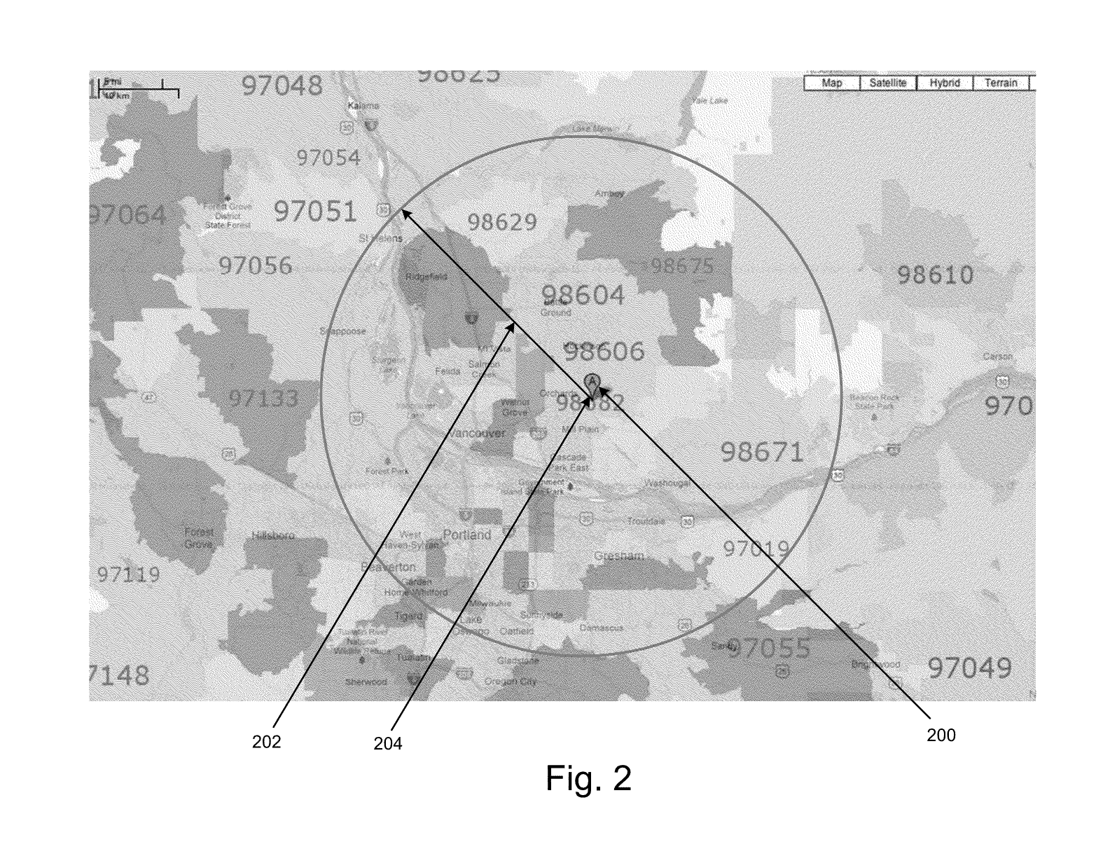

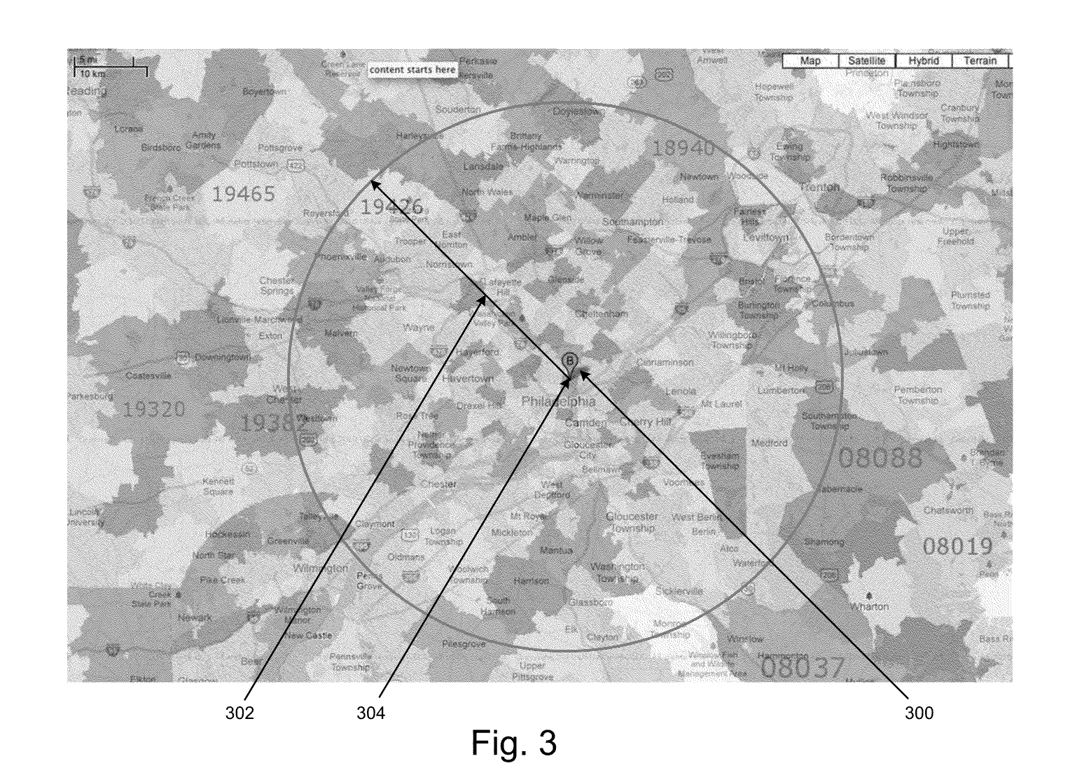

Referring to FIGS. 1-3, the coupon offer search module 108 is to search for coupon offers, for example, in a location entered by the user 106, and output coupon offers 110 that match appropriate search criteria. For example, the user 106 may initially enter the user's zip code, shown at 200, using the user interface 102. The user 106 may also enter a desired search radius 202 (e.g., 10 miles, or 20 miles). As shown in FIGS. 2 and 3, the search radius may govern how many zip codes are covered. For example, in the example of FIG. 2, a large search radius covers multiple zip codes (e.g., zip code 98604, 98606, 98671, etc.). In the example of FIG. 3, instead of the user's zip code 200, the user 106 enters a specific location 300 (e.g., home, work, or location of interest) and a search radius 302. Based on the user's zip code 200, a center point 204 of the zip code may be determined. Similarly, based on the specific location 300, a center point 304 of the specific location 300 may be determined. The latitude and longitudinal coordinates of the zip code center point 204 may be used to calculate a distance between the zip code center point 204 and the latitude and longitudinal coordinates of coupon offers, within the search area being defined by the user's zip code 200 and the search radius 202. Similarly, the latitude and longitudinal coordinates of the specific location center point 304 may be used to calculate a distance between the specific location center point 304 and the latitude and longitudinal coordinates of coupon offers, within the search area defined by the specific location 300 and the search radius 302. For example, assuming n coupon offers (i.e., C1, C2, C3, . . . , Cn) are located within the search area for the user's zip code 200 or the search area for the specific location 300, the located coupon offers may be ranked respectively by distance from the user's zip code center point 204 or the specific location center point 304.

The coupon offers located within the search area for the user's zip code 200 or the search area for the specific location 300 may also be ranked based on weight and scoring. For example, the weighting module 112 may assign weights 114 to the coupon offers 110 determined by the coupon offer search module 108. The weights may be assigned based, for example, on a distance of a coupon offer from the user's zip code center point 204 or the specific location center point 304. For the example of the user's zip code center point 204, each coupon offer may be assigned a weight based on a distance from the user's zip code center point 204. For example, a coupon offer located within 1 mile from the user's zip code center point 204 may be assigned a weight of 10, a coupon offer located within 2 miles from the user's zip code center point 204 may be assigned a weight of 9, and so forth. Coupon offers beyond the search area for the user's zip code 200 or the search area for the specific location 300 may be assigned negative weights. Thus, instead of the coupon offers being ranked by distance, the coupon offers may be ranked based on assigned weights. For example, the scoring module 118 may determine scores for each coupon offer, based, for example, on various weights assigned to each coupon offer by the weighting module 112. For the location based weights, the scores determined by the scoring module 118 may thus be identical to the weights assigned by the weighting module 112. If other weights are assigned by the weighting module 112 (e.g., weights based on user preferences, categories of coupon offers, etc.), the cumulative effect of all assigned weights may be evaluated for each coupon offer by the scoring module 118 to determine scores for each coupon offer. For the location based weights, the user 102 is therefore presented with coupon offers ranked based on assigned location based weights such that offers that are a minimal distance apart are not necessarily ranked below offers that are closer to the user's zip code center point 204 or the specific location center point 304.

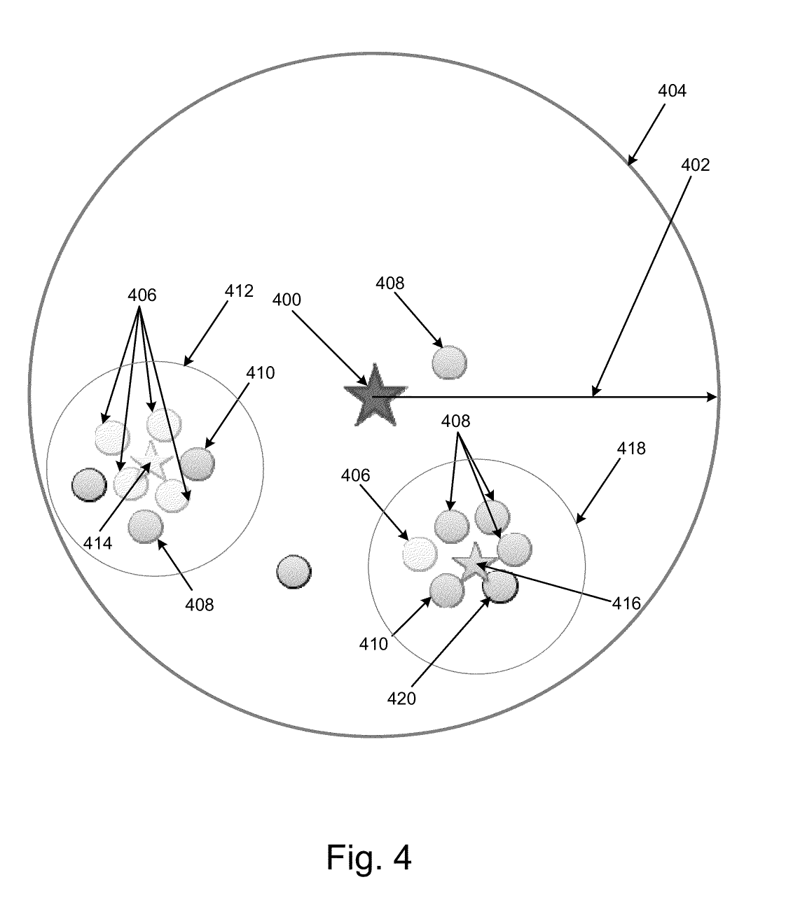

For the foregoing examples related to FIGS. 1-3, the user 106 may initially enter the user's zip code 200 or a specific location 300. If the user 106 enters the user's zip code 200 and no further information, the clustering module 116 may cluster coupon offers that are printed by the user 106 to discover new center point locations that may be of interest to the user 106. For example, referring to FIG. 4, assuming the user 106 enters the user's zip code, the center point of the user's zip code may be located at 400. The search area covered by the desired search radius 402 is shown at 404. Within the search area 404, the user 106 may select coupon offers that are generated by the coupon offer search module 108, with the locations of the coupon offers being represented by circles. Although not shown in FIG. 4, the user 106 may also select coupon offers outside of the search area 404. The coupon offers may belong to different categories, such as grocery, restaurants, pet supplies, etc. For example, coupon offers 406 may belong to a grocery category, coupon offers 408 may belong to a restaurant category, coupon offers 410 may belong to a pet supply category, etc. Once a predetermined number (e.g., 3, or 4) of coupon offers been printed in close proximity (i.e., within predetermined areas defined within the areas 412, 418), the clustering module 116 may cluster such coupon offers to discover new center point locations that may be of interest to the user 106. For example, if the user 106 prints three coupon offers 406 that belong to the grocery category, the location of the three coupon offers 406 may be used to infer a location of interest to the user 106. The inferred location of interest may be determined, for example, by triangulation using the coordinates of the three coupon offers 406. If further coupon offers of the same category are printed by the user 106 in close proximity to the center point of the new location of interest (i.e., within the area 412), the coordinates of the further coupon offers may be used to infer the location of interest with further accuracy, and to update the location of the center point of any newly discovered location of interest. In the example of FIG. 4, locations 414 and 416 respectively represent such new locations of interest that are inferred based on printing of three or more coupon offers 406 that belong to the grocery category and coupon offers 408 that belong to the restaurant category.

In order to determine whether new locations determined by the clustering module 116 are actually locations of interest to the user 106, or to evaluate a degree of interest by the user 106, the clustering module 116 may make such determinations based, for example, on a number of coupon offers that are printed by the user 106 for a specific category. For example, if the user 106 prints four coupon offers 406 that belong to the grocery category, the location 414 may be tagged as an actual location of interest to the user 106 for coupon offers that belong to the grocery category. For example, the location 414 may be tagged as a grocery category location. For the location 416, since the number of coupon offers 408 that belong to the restaurant category are three in the example shown, this location may be tagged as a potential location of interest to the user 106, without any specific coupon offer categories representing the location. Alternatively, a designation of an actual location of interest may be based on two or more, or otherwise, a user defined number of coupons that belong to a particular category.

Once an actual location of interest is tagged for the user 106, any coupon offers that exist in close proximity (e.g., within areas 412, 418) to that location may be assigned a weight 114 by the weighting module 112. For example, for the location 414, the coupon offers 406 that belong to the grocery category may be assigned a weight 114 of 1.0 by the weighting module 112. Similarly, for any further coupon offers that belong to the grocery category and are in close proximity to the location 414, such further coupon offers may also be assigned a weight 114 of 1.0 by the weighting module 112. Other coupon offers that are in close proximity to the location 414 and do not belong to the grocery category (e.g., coupon offers 408 that belong to the restaurant category, and coupon offers 410 belong to the pet supply category) may be assigned a weight 114 of 0.5 by the weighting module 112. Based on the assigned weights, the scoring module 118 may determine scores for each coupon offer. For example, for each of the coupon offers 406 that belong to the grocery category, the scoring module 118 may determine a cumulative score for each coupon offer based on the location based weighting (i.e., relative to the center point of the user's zip code represented by location 400, and the location 414) as described with reference to FIGS. 2 and 3, and the category based weighting (i.e., the grocery or other categories). The ranked coupon offers based on the cumulative scoring may be presented to the user 106 in order of highest to lowest cumulative scoring.

With regard to other potential locations of interest, such as the location 416, all coupon offers in close proximity to the center point of the location 416 (i.e., within area 418) may be assigned a weight 114 of 0.5 by the weighting module 112 since this location has not been tagged as an actual location of interest. The cumulative scores for the coupon offers within the area 418 may be determined by the scoring module 118 and the ranked coupon offers may be presented to the user 106 in order of highest to lowest cumulative scoring. If the user 106 selects a fourth coupon offer 408 that belongs to the restaurant category, the location 416 may be similarly tagged as an actual location of interest. For example, the location 416 may be tagged as a restaurant category location. The weight 114 of 1.0 may be assigned to the coupon offers 408 that belong to the restaurant category within the area 418. The cumulative scores for the coupon offers within the area 418 may be re-determined by the scoring module 118 based on the new weight assignment, and the ranked coupon offers may be presented to the user 106 in order of highest to lowest cumulative scoring. Thus, the weighting module 112 may assign a higher weight to a coupon offer for a particular category (e.g., grocery or restaurant) once a number of coupon offers for the particular category exceeds a predetermined threshold (e.g., 3 coupon offers, or a user-defined number of coupon offers). The user 106 may also configure, select and/or define various categories for coupon offers.

The newly discovered center point locations (e.g., locations 414, 416) may be used to further discover possible home, work and other locations relevant to the user 106. For example, coupon offers that belong to restaurant and lunch categories may classified as work related coupon offers, whereas coupon offers that belong to restaurant and dinner categories may classified as home related coupon offers. Coupon offers that belong to a grocery category may be classified as home related coupon offers. Further, coupon offers that belong to a clothing category may be classified as coupon offers related to the user's preferred shopping locations. In this manner, based on the type of coupon offers that are printed by the user 106, any newly discovered locations may also be tagged as home, work and other locations relevant to the user 106.

For multiple locations discovered based on clustering by the clustering module 116, such locations may be weighted based, for example, on other aspects such as frequency of coupon offer selection, the overall number of coupon offers selected, household information, and user actions, such as like, dislike, hide, etc. For example, disliking a set of coupon offers for a specific location may be used to eliminate or lower the ranking of possible coupon offers for a newly discovered center point location, or otherwise coupon offers within the search area 404. For example, a high frequency of coupon offer selection for a particular category may be used to assign a higher weight to such coupon offers in a particular category. For example, if a user selects a particular category of coupon offers at a predetermined rate within a predetermined time-period, such high frequency selected coupon offers may be assigned a higher weight in the particular category. Similarly, different weights may be assigned to user actions, such as like, dislike, hide, etc. For example, if a user likes a coupon offer or a coupon offer category, such coupon offers may be assigned a weight of 1.0, if a user dislikes a coupon offer or a coupon offer category, such coupon offers may be assigned a weight of 0.3, and if a user hides a coupon offer or a coupon offer category, such coupon offers may be assigned a weight of 0.0. For each coupon offer, the scoring module 118 may determine scores for each aspect (e.g., location, offer category, frequency of coupon offer selection, user actions such as like, dislike, hide, etc.), and further determine cumulative scores for each coupon offer. The cumulative scores for each coupon offer may be used to rank coupon offers, and the ranked coupon offers may be presented to the user 106 in order of highest to lowest cumulative scoring.

The decay rate module 120 may determine a decay rate of any actions performed by the user 106 such that more recent user actions are assigned a higher weight compared to older user actions. For example, any action performed by the user 106 to print, like, dislike, hide, etc., coupon offers may be assigned a time stamp and a predetermined decay rate period (e.g., 30 days). The decay rate period may be assigned a corresponding weight for each day such that when the user first performs an action on a coupon offer, that action is time stamped and given the highest weight (e.g., 1.0). For each day after the initial action by the user 106, the weight assigned to the action may be reduced based on the decay rate (e.g., by 1/30), such that after a 30 day period, the weight assigned to the action is 0.0. In this manner, the weight assigned to an action performed by the user 106 may decay over a predetermined time period. For example, referring to FIG. 4, if the user 106 prints a coupon offer 420 related to entertainment, if no further entertainment based coupon offers are printed for a period of 30 days (e.g., a decay rate of 30 days), the significance and thus the weight impact of such a coupon offer is reduced over time. The decay rate module 120 thus accounts for changes, for example, in the behavior, location, or other factors related to the user 106. The user 106 may use the user interface 102 to prevent such decay rates being applied to user actions, and to other actions performed by the coupon offer personalization apparatus 100.

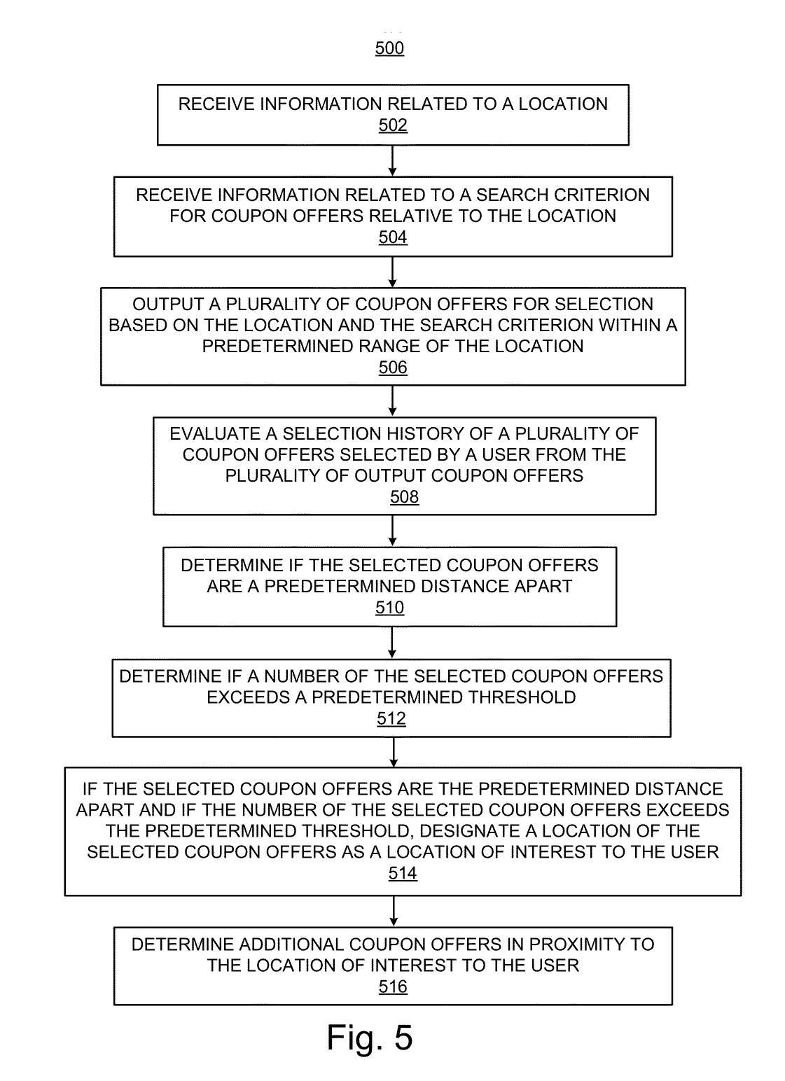

FIG. 5 illustrates a flowchart of a method 500 for coupon offer personalization, corresponding to the example of the coupon offer personalization apparatus 100 whose construction is described in detail above. The method 500 may be implemented on the coupon offer personalization apparatus 100 with reference to FIG. 1 by way of example and not limitation. The method 500 may be practiced in other apparatus.

Referring to FIG. 5, for the method 500, at block 502, information related to a location is received. For example, referring to FIG. 1, the user interface 102 receives user input 104 from the user 106 related, for example, to a location of interest for coupon offers, coupon offer categories of interest, etc.

At block 504, information related to a search criterion for coupon offers relative to the location is received. For example, referring to FIG. 1, the user interface 102 receives user input 104 from the user 106 related, for example, to a search criterion (e.g., groceries, entertainment, etc.) for coupon offers relative to the location.

At block 506, a plurality of coupon offers are output for selection based on the location and the search criterion within a predetermined range of the location. For example, referring to FIG. 1, the coupon offer search module 108 may search for coupon offers, for example, in a location entered by the user 106, and output coupon offers 110 that match appropriate search criteria.

At block 508, a selection history of a plurality of coupon offers that are selected by a user from the plurality of output coupon offers is evaluated. For example, referring to FIGS. 1 and 4, a selection history of a plurality of coupon offers (e.g., coupon offers 406, 408, 410, 420) that are selected by a user from the plurality of output coupon offers (e.g., all coupon offers output by the search module 108) is evaluated, with the coupon offers selected by the user being designated selected coupon offers.

At block 510, a determination is made whether the selected coupon offers are a predetermined distance apart. For example, referring to FIGS. 1 and 4, a determination is made whether the selected coupon offers are within the areas 412 or 418.

At block 512, a determination is made whether a number of the selected coupon offers exceeds a predetermined threshold. For example, referring to FIGS. 1 and 4, a determination is made whether a number of the selected coupon offers (e.g., a number of the coupon offers 406 or 408) exceeds a predetermined threshold (e.g., three coupon offers for the example of FIG. 4).

At block 514, if the selected coupon offers are the predetermined distance apart and if the number of the selected coupon offers exceeds the predetermined threshold, a location of the selected coupon offers is designated as a location of interest to the user. For example, referring to FIGS. 1 and 4, the locations 414, 416 of the selected coupon offers are designated as locations of interest to the user 106. As further discussed with reference to the example of FIG. 4, the location 414 may be tagged as a grocery category location, and the location 416 may be tagged as a restaurant category location.

At block 516, additional coupon offers are determined in proximity to the location of interest to the user. For example, referring to FIG. 1, additional coupon offers are determined in proximity to the location of interest to the user (e.g., locations 414, 416), and displayed on the user interface 102.

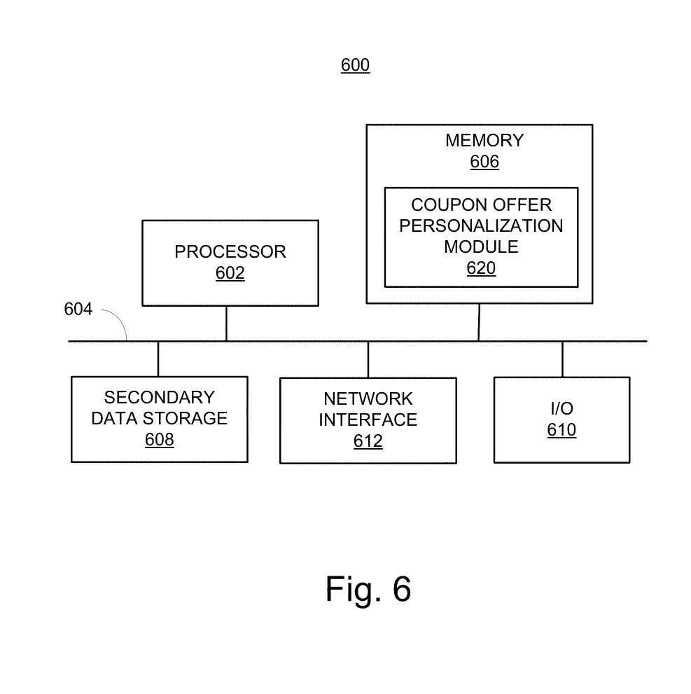

FIG. 6 shows a computer system that may be used with the examples described herein. The computer system represents a generic platform that includes components that may be in a server or another computer system. The computer system may be used as a platform for the apparatus 100. The computer system may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system includes a processor 602 that may implement or execute machine readable instructions performing some or all of the methods, functions and other processes described herein. Commands and data from the processor 602 are communicated over a communication bus 604. The computer system also includes a main memory 606, such as a random access memory (RAM), where the machine readable instructions and data for the processor 602 may reside during runtime, and a secondary data storage 608, which may be non-volatile and stores machine readable instructions and data. The memory and data storage are examples of computer readable mediums. The memory 606 may include a coupon offer personalization module 620 including machine readable instructions residing in the memory 606 during runtime and executed by the processor 602. The coupon offer personalization module 620 may include the modules 108, 112, 116, 118 and 120 of the apparatus shown in FIG. 1.

The computer system may include an I/O device 610, such as a keyboard, a mouse, a display, etc. The computer system may include a network interface 612 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for coupon offer personalization, the method comprising:
receiving information related to a location;
receiving information related to a search criterion for coupon offers relative to the location;
outputting a plurality of coupon offers for selection based on the location and the search criterion within a predetermined range of the location;
evaluating a selection history of a plurality of coupon offers selected by a user from the plurality of output coupon offers, the coupon offers selected by the user being designated selected coupon offers;
determining if the selected coupon offers are a predetermined distance apart;
determining if a number of the selected coupon offers exceeds a predetermined threshold;
if the selected coupon offers are the predetermined distance apart and if the number of the selected coupon offers exceeds the predetermined threshold, designating a location of the selected coupon offers as a location of interest to the user; and
determining, by a processor, additional coupon offers in proximity to the location of interest to the user.

2. The method of claim 1, wherein information related to the location includes a zip code.

3. The method of claim 1, wherein evaluating a selection history of a plurality of coupon offers selected by a user from the plurality of output coupon offers further comprises:
determining distances between a center point of the location and the selected coupon offers.

4. The method of claim 3, further comprising:
determining the distances based on latitude and longitude coordinates of the center point of the location and the selected coupon offers.

5. The method of claim 1, wherein determining if a number of the selected coupon offers exceeds a predetermined threshold further comprises:
determining if the selected coupon offers are related to a category; and
determining if the number of the selected coupon offers related to the category exceeds a predetermined threshold related to the category.

6. The method of claim 1, wherein determining if a number of the selected coupon offers exceeds a predetermined threshold further comprises:
determining if the selected coupon offers are related to a category that is modifiable by the user.

7. The method of claim 1, wherein determining if a number of the selected coupon offers exceeds a predetermined threshold further comprises:
determining if the selected coupon offers are related to a user action; and
determining if the number of the selected coupon offers related to the user action exceeds a predetermined threshold related to the user action.

8. The method of claim 7, wherein the user action includes one of liking, disliking, and hiding a coupon offer.

9. The method of claim 1, wherein the predetermined threshold is two coupon offers, the method further comprising:
determining the location of interest to the user based on triangulation using locations of at least three of the selected coupon offers.

10. The method of claim 1, wherein determining additional coupon offers in proximity to the location of interest to the user further comprises:
determining the additional coupon offers within a predetermined distance to the location of interest to the user.

11. The method of claim 1, further comprising:
assigning at least one weight to each of the selected coupon offers and the additional coupon offers based on at least one of:
categories of the selected coupon offers and the additional coupon offers,
locations of the selected coupon offers and the additional coupon offers,
frequency of selection of the selected coupon offers, and
actions performed by the user related to the selected coupon offers.

12. The method of claim 1, further comprising:
assigning at least one weight to each of the selected coupon offers and the additional coupon offers;
determining a score for each of the selected coupon offers and the additional coupon offers based on the at least one assigned weight; and
ranking the selected coupon offers and the additional coupon offers based on the score for each of the selected coupon offers and the additional coupon offers.

13. The method of claim 1, further comprising:
assigning at least one weight to each of the selected coupon offers;
assigning a time stamp to each of the selected coupon offers;
determining a decay rate of each of selected coupon offers from the time stamp; and
modifying the at least one assigned weight based on the decay rate.

14. A coupon offer personalization apparatus comprising:
a memory storing machine readable instructions to:
receive information related to a location;
receive information related to a search criterion for coupon offers relative to the location;
output a plurality of coupon offers for selection based on the location and the search criterion within a predetermined range of the location;
evaluate a selection history of a plurality of coupon offers selected by a user from the plurality of output coupon offers, the coupon offers selected by the user being designated selected coupon offers;
determine if the selected coupon offers are related to a category;
determine if a number of the selected coupon offers related to the category exceeds a predetermined threshold related to the category;
if the number of the selected coupon offers exceeds the predetermined threshold related to the category, designate a location of the selected coupon offers as a location of interest to the user; and
determine additional coupon offers in proximity to the location of interest to the user; and
a processor to implement the machine readable instructions.

15. A non-transitory computer readable medium having stored thereon machine readable instructions for coupon offer personalization, the machine readable instructions when executed cause a computer system to:
receive information related to a location;
receive information related to a search criterion for coupon offers relative to the location;
output a plurality of coupon offers for selection based on the location and the search criterion within a predetermined range of the location;
evaluate a selection history of a plurality of coupon offers selected by a user from the plurality of output coupon offers, the coupon offers selected by the user being designated selected coupon offers;
determine if the selected coupon offers are related to a user action;
determine if a number of the selected coupon offers related to the user action exceeds a predetermined threshold related to the user action;
if the number of the selected coupon offers exceeds the predetermined threshold related to the user action, designate a location of the selected coupon offers as a location of interest to the user; and
determine, by a processor, additional coupon offers in proximity to the location of interest to the user.
